(19) United States
(12) Patent Application Publication
(10) Pub. No.: US 2023/0399878 A1
(43) Pub. Date: Dec. 14, 2023

(54) CARGO CONTAINER WITH INTEGRATED LOCKING APPARATUS

(71) Applicant: David Lyon Sherwood, Abbotsford (CA)

(72) Inventor: David Lyon Sherwood, Abbotsford (CA)

(21) Appl. No.: 17/806,612

(22) Filed: Jun. 13, 2022

(51) Int. Cl. E05B 83/02; E05B 81/02

(52) U.S. Cl. CPC E05B 83/02; E05B 81/02

(57) ABSTRACT

A cargo container with integrated locking apparatus that is configured to provide operational control of an overhead style door that is operably coupled to the cargo container so as to allow or inhibit movement thereof. An actuator assembly is mounted adjacent a track configured to have wheels of an overhead door traverse therethrough. The actuator assembly is operably coupled to a movement assembly via a drive member. The drive member is movable between a first and second position and is operable to move the first lever arm and second lever arm of the movement assembly. The movement assembly is operably coupled to a pin member wherein the pin member is operably coupled to the second lever arm. The pin member is movable between a first and second position wherein in the second position the pin member extends into the track so as to inhibit movement of a wheel therepast.

### FIELD OF THE INVENTION

The present invention relates generally to security and storage devices, more specifically but not by way of limitation, a cargo container having an access point utilizing an overhead style door wherein the present invention provides integration of an internal locking apparatus configured to inhibit operation of the overhead style door.

### BACKGROUND

As is known in the art, overhead style doors are routinely employed on various objects such as but not limited to cargo trucks, garages and various types of large containers. Cargo trucks and trailers almost exclusively employ the overhead style door wherein the door is segmented and employs wheels to move upwards and downwards on tracks located on each side of the door. The tracks are located inside of the container or cargo track and the door is moved upwards to access the interior volume of the cargo truck or container. Most containers and cargo trucks have a latch positioned on the exterior of the door. This latch is typically has a hook-shaped portion and is movable so as to engage the hook-shaped portion with a portion of the container or cargo truck when the door is in its closed position. The latch is also equipped with a set of apertures that can be used to operably coupled a padlock therethrough to inhibit operation of the latch.

One issue with cargo trucks and the conventional arrangement of the overhead door and latch is security. In order to inhibit access to the interior of the cargo truck an individual must utilize a padlock or similar device to render the latch inoperable and as such maintain the overhead door in a closed position. As is known in the art, cargo trucks are routinely utilized for deliveries. In particular, it is common for an operator of the cargo truck to have a load wherein items from the load are delivered separately. During deliveries it can be common for an operator to leave the cargo truck unattended. Millions of dollars of goods are stolen every year from cargo trucks that are left briefly unattended while an operator delivers items from the truck into a business. As utilizing the latch and a padlock is the only manner to inhibit access to the cargo truck, due to its inconvenience this Is typically not done by an operator of a cargo truck.

Accordingly, there is a need for a cargo truck wherein the truck is equipped with an automated locking apparatus that can facilitate fast and efficient locking of the overhead door so as to inhibit access thereto during absence of the operator.

### SUMMARY OF THE INVENTION

It is the object of the present invention to provide a cargo container having an integrated locking apparatus for an overhead door thereof wherein the present invention includes an actuator assembly.

Another object of the present invention is to provide a locking apparatus for an overhead door that is located on a cargo truck wherein the actuator assembly is configured to be operated with a remote controller.

A further object of the present invention is to provide a cargo container having an integrated locking apparatus for an overhead door thereof wherein the actuator assembly is operably coupled to a movement assembly.

Still another object of the present invention is to provide a locking apparatus for an overhead door that is located on a cargo truck wherein the movement assembly is operably coupled to a pin member.

An additional object of the present invention is to provide a cargo container having an integrated locking apparatus for an overhead door thereof wherein the pin member is movable between a first position and a second position.

Yet a further object of the present invention is to provide a locking apparatus for an overhead door that is located on a cargo truck wherein the pin member is mounted adjacent to a track of the overhead door.

Another object of the present invention is to a provide a cargo container having an integrated locking apparatus for an overhead door thereof wherein in its second position the pin member is positioned so as to have a portion thereof project into the track of the overhead door.

An additional object of the present invention is to provide a locking apparatus for an overhead door that is located on a cargo truck wherein the present invention is mounted within a cavity behind a rear light assembly of the cargo truck.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary cargo container having with integrated locking apparatus mounted in tail light cavity; and

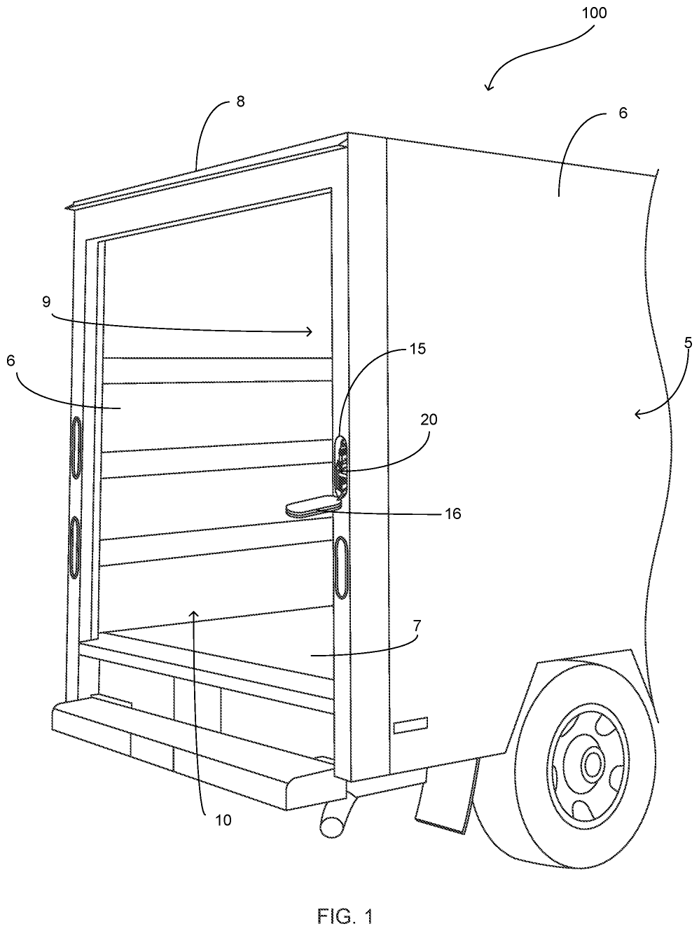

FIG. 2 is a side view of an embodiment of the present invention; and

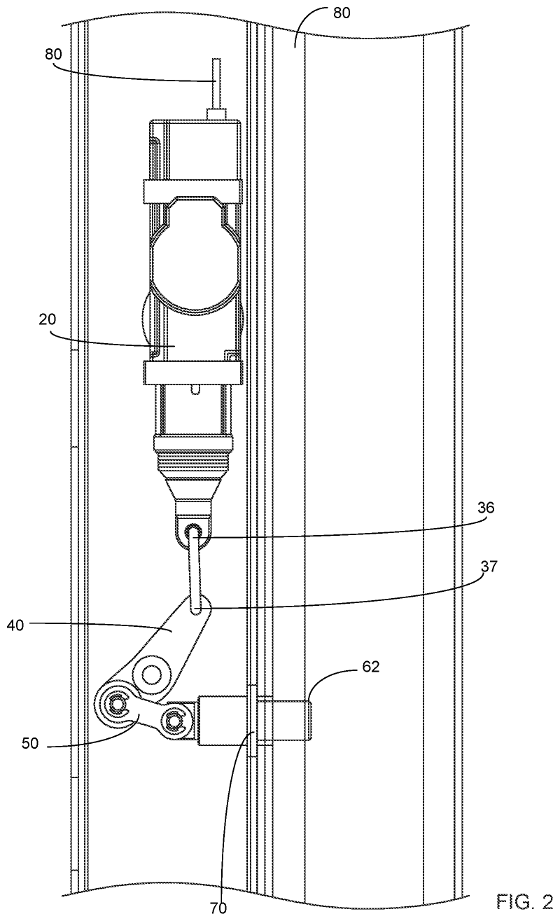

FIG. 3 is a detailed side view of an embodiment of the present invention.

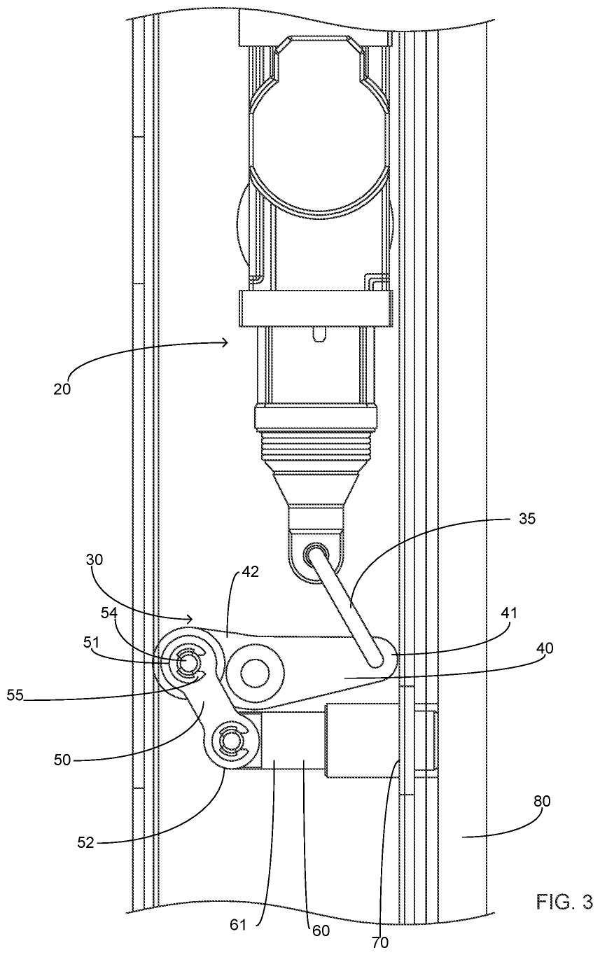

### DETAILED DESCRIPTION

Referring now to the drawings submitted herewith, wherein various elements depicted therein are not necessarily drawn to scale and wherein through the views and figures like elements are referenced with identical reference numerals, there is illustrated a cargo container with integrated locking apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the cargo container with integrated locking apparatus 100 includes a container 5 wherein the illustrated embodiment herein is part of a container truck. It should be understood within the scope of the present invention that the present invention could be embodied in various alternate embodiment that include any structure capable of receiving, storing and transporting goods that includes an overhead door for accessing the interior volume thereof. The container 5 includes walls 6, bottom, 7 and top 8 operably coupled to create the interior volume 9. An opening 10 provides access to the interior volume 9 and while not particularly illustrated herein, the opening 10 has a conventional overhead style door providing controlled access to the interior volume 9. It should be understood within the scope of the present invention that the container 5 could be provided in alternate sizes and be secured to a frame of a truck or be a stationary container.

The container 5 includes a cavity 15 formed in the wall 6. The cavity 15 in the embodiment illustrated herein is formed forward of a tail light assembly 16. The tail light assembly 16 is releasably secured to the wall 6 so as to provide access to the cavity 15. The cavity 15 is configured to be of suitable size so as to receive and have mounted therein the locking apparatus 100. It should be understood within the scope of the present invention that the cavity 15 in alternate embodiments would be formed in the wall 6 with no tail light assembly present and access thereto would be provided by alternate elements. It should be understood within the scope of the present invention that the cavity 15 could be formed in alternate locations that are adjacent the track 80.

The cargo container with integrated locking apparatus 100 includes actuator assembly 20 as a part thereof. The actuator assembly 20 is mounted adjacent to track 80 wherein the track 80 is a conventional overhead style door track that is formed to have wheels of an overhead door captively roll therein. As is known in the art, wheels secured to the lateral sides of an overhead door traverse along the track 80 to move the overhead style door in between its closed position and its open position. The actuator assembly 20 is mounted adjacent to the track utilizing suitable mechanical techniques. The actuator assembly 20 includes a housing 21 manufactured from a durable rigid material such as but not limited to plastic or metal. It is contemplated within the scope of the present invention that the actuator assembly 20 can be either a conventional hydraulic or electrical actuator. The actuator assembly 20 is operably coupled to the movement assembly 30 and provides operation thereof as is further discussed herein. The actuator assembly 20 is directly coupled to a drive member 35. Drive member 35 is manufactured from a rigid material such as but not limited to metal and extends downward from the housing 21. The drive member 35 has a first end 36 and second end 37. The drive member 35 is movable between a first position and a second position. It is contemplated within the scope of the present invention that the actuator could move the drive member 35 in various directions in order to accomplish the desired objective as is discussed herein. By way of example but not by limitation, the drive member 35 could be moved in either an upwards-downwards direction or laterally by the actuator assembly 20 in order to control the movement assembly 30 as needed.

The second end 37 of the drive member 35 is operably coupled to first lever arm 40 of the movement assembly 30. The second end 37 is movably coupled to the first lever arm 40. First lever arm 40 includes a first end 41 and a second end 42. While the first lever arm 40 is illustrated herein as being slightly tapered in shape with a width proximate the first end 41 that is less than that of the width proximate the second end 42, it should be understood within the scope of the present invention that the first lever arm 40 could be provided in alternate sizes and shapes. The first lever arm 40 is operably coupled to the second lever arm 50. The second lever arm 50 is rotatably coupled to the first lever arm 40 wherein the second end 42 of the first lever arm 40 is rotatably coupled to the first end 51 of the second lever arm 50. The second lever arm 50 is secured to the first lever arm 40 utilizing pin 54 and retaining clip 55 but it should be understood within the scope of the present invention that the alternate connection elements could be employed to accomplish the desired objective. The second end 52 of the second lever arm 50 is operably coupled to pin member 60.

The pin member 60 is movably coupled to second lever arm 50 and is movable between a first position and a second position. The pin member 60 is cylindrical in shape having a first end 61 and a second end 62. Pin member 60 is operably coupled to mount 70 wherein the mount 70 provides mounting of pin member 60 adjacent to track 80. The mount 70 is constructed so as to allow the pin member 60 to move between the first position and second position of the pin member 60. The pin member 60 in a preferred embodiment of the cargo container with integrated locking apparatus 100 moves in a forward-backward motion. In the first position the second end 62 of the pin member 60 is retracted from the track 80 so as to allow a wheel of an overhead door to traverse through the track without interfering therewith. In the second position of the pin member 60, the pin member 60 has been moved so as to place the second end 62 partially into the track 80. In the second position the second end 62 of the pin member 60 extends into the track 80 so as to inhibit a wheel from rolling therepast. In the second position the pin member 60 is capable of inhibiting an overhead style door being moved to an open position.

The actuator assembly 20 includes a transceiver 90 wherein the transceiver 90 is operably coupled to the actuator assembly 20 and provides control thereof. The transceiver 90 is a conventional transceiver that includes the necessary electronics to receive, store, transmit and manipulate data. The transceiver 90 is configured to receive a signal from a remote controller (not particularly illustrated herein) so as to provide operation of the actuator assembly 20. The remote controller is utilized to move the pin member 60 between its first position and second position so as to either allow or inhibit movement of an overhead style door operably coupled to the container 5. While a pin member 60 embodiment has been illustrated and discussed herein, it is contemplated within the scope of the present invention that the pin member 60 could be provided in alternate embodiments as well as be replaced with different elements in order to accomplish the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A cargo container with integrated locking apparatus that is configured to control operation of an overhead door operably coupled to the cargo container wherein the cargo container with integrated locking apparatus comprises:
a container, said container having a plurality of walls, bottom and a top forming an interior volume, said container having an opening providing access to the interior volume, said interior volume configured to receive and store items;
a cavity, said cavity being formed in one of said plurality of walls, said cavity being adjacent the opening;
an actuator assembly, said actuator assembly being mounted adjacent a track, said actuator assembly having a drive member operably coupled thereto;
a movement assembly, said movement assembly being operably coupled to said drive member, said movement assembly having at least one lever arm;
a pin member, said pin member being operably coupled to said movement assembly, said pin member being movable between a first position and a second position; and
wherein in said second position said pin member is operable to project into the track so as to inhibit a wheel from traversing therepast.

2. The cargo container with integrated locking apparatus as recited in claim 1, wherein said container is secured to a frame of a vehicle.

3. The cargo container with integrated locking apparatus as recited in claim 2, and further including a transceiver, said transceiver being operably coupled to said actuator assembly, said transceiver being operably coupled to a remote control.

4. The cargo container with integrated locking apparatus as recited in claim 3, wherein said drive member is movable between a first position and a second position, said movement of said drive member being controlled by said actuator assembly.

5. The cargo container with integrated locking apparatus as recited in claim 4, wherein the actuator assembly moves the drive member in one of the following directions: laterally or upwards-downwards.

6. The cargo container with integrated locking apparatus as recited in claim 5, wherein the cavity is adjacent to a tail light assembly installed on the container.

7. A locking apparatus for an overhead door on a cargo delivery truck wherein the locking apparatus controls operation of an overhead door operably coupled to the cargo container of the delivery truck wherein the locking apparatus comprises:
an actuator assembly, said actuator assembly having a housing, said actuator assembly being mounted adjacent a track, said actuator assembly having a drive member operably coupled thereto, said drive member having a first end and a second end, said actuator assembly configured to move said drive member between a first position and a second position;
a movement assembly, said movement assembly being operably coupled to said second end of said drive member, said movement assembly having a first lever arm, said first lever arm having a first end and a second end, said first end of said first lever arm being operably coupled with said second end of said drive member, said movement assembly having a second lever arm, said second lever arm having a first end and a second end, said first end of said second lever arm being operably coupled to said second end of said first lever arm, said movement assembly movable in response to the drive member movement between said first position and said second position;
a pin member, said pin member being operably coupled to said second end of said second lever arm, said pin member being cylindrical in shape, said pin member having a first end and a second end, said pin member having a first position and a second position; and
wherein in said second position said second end of said pin member extends into the track.

8. The locking apparatus for an overhead door on a cargo delivery truck as recited in claim 7, and further including a pin mount, said pin mount being operably coupled to said pin member, said pin mount being secured adjacent to the track, said pin member being movable within said pin mount.

9. The locking apparatus for an overhead door on a cargo delivery truck as recited in claim 8, and further including a transceiver, said transceiver being operably coupled to said actuator assembly, said transceiver being operably coupled to a remote control.

10. The locking apparatus for an overhead door on a cargo delivery truck as recited in claim 9, wherein the locking apparatus is mounted in a cavity formed in the cargo container, wherein the cavity has a tail light releasably secured thereto.

11. The locking apparatus for an overhead door on a cargo delivery truck as recited in claim 10, wherein the actuator assembly moves the drive member in one of the following directions: laterally or upwards-downwards.

12. The locking apparatus for an overhead door on a cargo delivery truck as recited in claim 11, wherein said actuator assembly is selected from one of the following: electric or hydraulic.
